(19) United States
(12) Patent Application Publication
(10) Pub. No.: US 2024/0169766 A1
(43) Pub. Date: May 23, 2024

(54) TELEMATICS AS A METHOD TO MONITOR THE STATE OF AIR FILTERS USED WITH FUEL CELLS

(71) Applicant: International Engine Intellectual Property Company, LLC, Lisle, IL (US)

(72) Inventor: Bradley Jay Adelman, Chicago, IL (US)

(21) Appl. No.: 17/991,506

(22) Filed: Nov. 21, 2022

(51) Int. Cl. G07C 5/00; G07C 5/08

(52) U.S. Cl. CPC G07C 5/006; G07C 5/0808; G07C 5/0825; G07C 5/085

(57) ABSTRACT

The present invention utilizes telematics to determine a chemical contamination of an air filter used with a fuel cell. GPS is preferably used to monitor the location of a vehicle. Each geographic location contains different chemical contaminants with different concentrations. The concentration of chemical contaminants to which the air filter is exposed is calculated by tracking the amount of time spent in the at least one geographic area over a period of time by a telematic software routine. The telematic software routine preferably resides in an ECM/VCM of a vehicle. Historical data can be the source of chemical contaminants found in a particular the geographic area. Preferably a live source broadcast of the chemical contamination information is used, instead of the historical data. An alert to change the air filter is sent to the vehicle operator when the air filter is saturated with at least one chemical contaminant.

### FIELD OF THE INVENTION

The present invention pertains to using telematics to monitor the state of an air filter for chemical contamination for fuel cell electric vehicles.

### RELATED ART

Fuel cell electric vehicles (FCEV) require additional filtration of the intake air that is not needed for standard internal combustion engines (ICE). Fuel cells are used to convert hydrogen and oxygen into an electrical output. For ICE, only particulate matter (mostly dust) needs to be removed from the intake air. For FCEV, the intake air requires chemical filtration of such contaminants as NOx, SO2, volatile organic compounds (VOC), and ammonia. The status of standard filters used with ICE can be monitored by restriction across the medium. Unfortunately, for an air filter used with FCEV, the limits of chemical trapping efficiency is reached well before the physical trapping results in sufficient increase in restriction to detect that the filter needs to be replaced. The state of chemical trapping cannot be measured with sensors, so filter replacement is based on assumed levels of chemical exposure: intake air flow rates and assumed ambient concentrations of the contaminants. The ambient concentrations will vary based on geographic location. Most urban areas, such as the Los Angeles basin have much higher ambient NOx concentrations than rural areas. Therefore, a vehicle traveling a mostly urban drive cycle would reach the exposure limits more rapidly than a vehicle traveling cross-country. The current method for determining air filter replacement for the fuel cell electric vehicles cannot account for the differences in ambient conditions in different geographic areas. Patent publication no. 2013/0220900 to Milvert et al. discloses a filter communication and identification network. Patent no. 10119886 to Dhingra et al. discloses a filtration monitoring system.

Accordingly, there is a clearly felt need in the art for utilizing telematics such as GPS (global positioning system) to determine the state of air filters for chemical contamination used with fuel cells by modeling the chemical contaminants that the chemical air filters are exposed to when passing through at least one geographic area; which eliminates replacing the filter too soon or not soon enough by providing a better indication of the chemical contamination of the chemical air filter; and not replacing the chemical air filter when thereof is saturated with chemical contaminants that could damage the cathode catalyst.

### SUMMARY

The present disclosure utilizes telematics to determine the chemical contamination of an air filter used with a fuel cell by associating the chemical contaminants found in at least one geographic area with the amount of time that the vehicle spends in the at least one geographic area to model the amounts of chemical contaminants that should be found in the air cleaner and alerting the operator to change the chemical air filter. GPS is preferably used to monitor the location of a vehicle and the time that the vehicle spends in the geographic location. Each geographic location usually contains different types and amounts of chemical contaminants. Historical data can be compiled to associate the type and amount each type of chemical contaminants found in a particular the geographic area. However, a live source broadcast of information concerning the types and amounts of chemical contaminants found in a particular geographic area is preferably used instead of historical data, when the live source broadcast is available.

The maximum ppm (parts per million) of each chemical contaminant which will be trapped in the chemical air filter, before the chemical air filter is no longer capable of chemical filtration (fill-state) of the chemical air filter is determined. The chemical contaminants include NOX (Nitrogen oxides), SO₂ (Sulphur dioxide), VOC (volatile organic compound) and ammonia. Exposure to each chemical contaminant over a period time is calculated from the time spent in every geographic location and the chemical contaminants in the geographic location. When at least one of the chemical contaminants reach the maximum threshold, the chemical air filter must be replaced. If the vehicle operates in geographic area(s) where ambient concentrations of chemical contaminants are high, the chemical air filter must be replaced more frequently. If the vehicle operates in geographic area(s) where ambient concentrations of chemical contaminants are low, the air chemical filter is replaced less frequently. An accurate count of chemical contaminants in the chemical air filter will ensure that the fuel cell is protected from damage, while minimizing down time and reducing cost of ownership of the vehicle.

A software routine will receive historical data or live data concerning the chemical contaminants in at least one geographic area in which the vehicle is driven. The software routine is preferably retained in an ECM/VCM (vehicle control module) or any other suitable control module. The ECM directly controls all the parameters that are monitored through direct connections to sensors and actuators. The VCM acts as a central control and coordination hub for many subsystems' ECMs using high-level commands.

### DESCRIPTION OF THE DRAWINGS

FIG. 1 is a schematic diagram of a fuel cell used in a hydrogen powered electric vehicle.

FIG. 2 is a schematic diagram of an air filter box, which filters chemical contaminants from air input by a fuel cell used in a hydrogen powered electric vehicle.

FIG. 3 is a schematic diagram of how chemical contaminant data is processed by a software routine.

### DETAILED DESCRIPTION

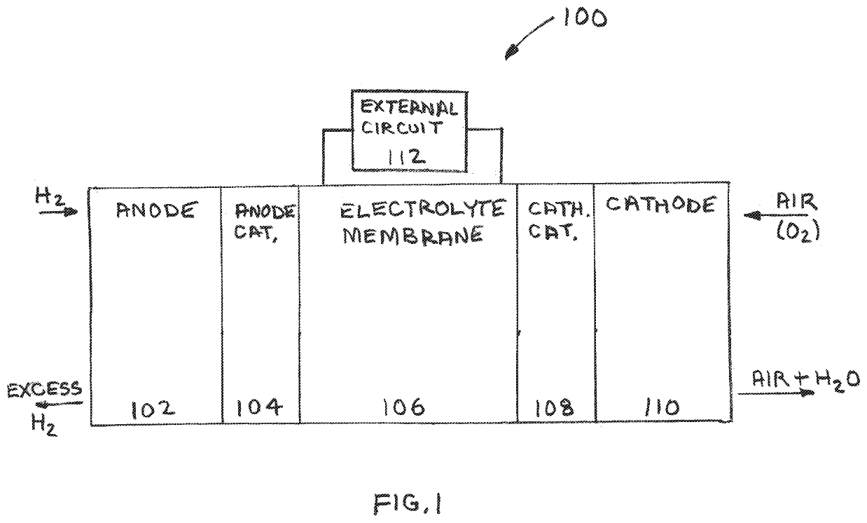

With reference now to the drawings, and particularly to FIG. 1, there is shown a hydrogen powered fuel cell 100. The fuel cell 100 generates electrical power from hydrogen gas and ambient air. The fuel cell 100 includes an anode 102, an anode catalyst 104, an electrolyte membrane 106, a cathode catalyst 108, a cathode 110 and an external circuit 112. The anode 102 receives hydrogen gas. The hydrogen gas passes into the anode catalyst 104. The cathode 110 receives oxygen in the form of ambient air. The oxygen passes into the cathode catalyst 108. Hydrogen molecules break apart into protons and electrons due to an electrochemical reaction in the anode catalyst 104. Protons then travel through the electrolyte membrane 106 to the cathode 110. The electrons are forced to travel through the external circuit 112 to supply electrical current. The electrons recombine with the protons on the cathode side where the protons, electrons, and oxygen molecules combine to form water. The air and the water are exhausted through a tail pipe.

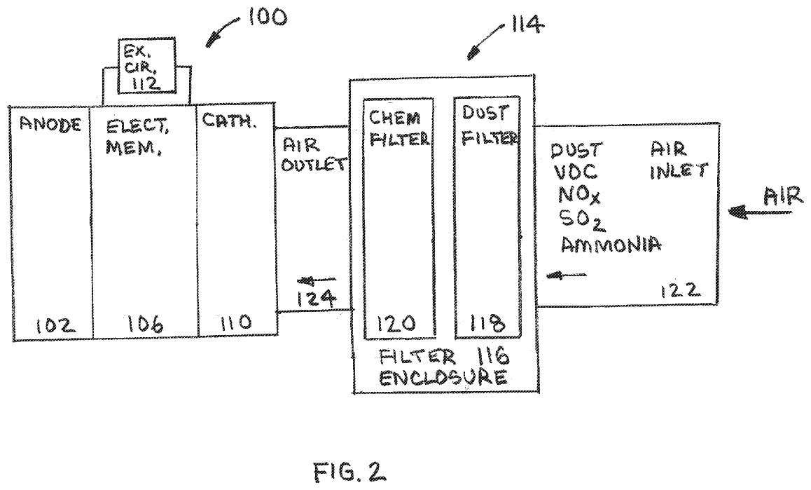

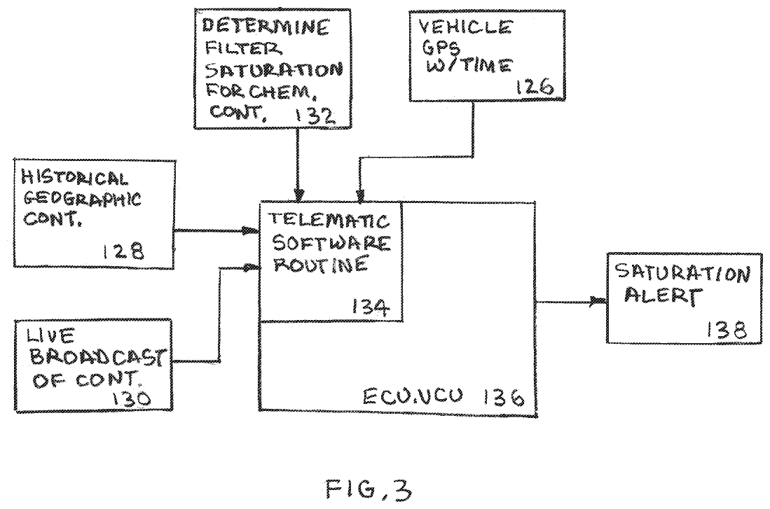

With reference to FIG. 2, an air filter box 114 includes a filter enclosure 116, a dust filter 118, a chemical filter 120, an inlet 122 and an outlet 124. The dust filter 118 filters dust and other particles. The chemical filter 120 filters NOX, SO₂, VOC and ammonia. Ambient air enters the inlet 120 and passes through the dust and chemical filters 118, 120 and exits the outlet 122. The outlet 122 supplies the cathode 110 with filtered ambient air. With reference to FIG. 3, GPS is preferably used to monitor the location of a vehicle and the time that the vehicle spends in the geographic location in box 126, while the fuel cell 100 is supplying electrical power, but other location devices or methods could also be used. Each geographic location usually contains different types and amounts of chemical contaminants. Historical data can be compiled to associate the types and amount each chemical contaminant found in a particular geographic area in box 128. However, a live source broadcast of information concerning chemical contaminants in a particular geographic area in box 130 is preferably used instead of historical data, when the live source broadcast is available. The maximum ppm (parts per million) of each chemical contaminant which will be trapped in the chemical filter 120, before the chemical filter 120 is no longer capable of chemical filtration (fill-state, saturation or inefficient trapping efficiency) is determined in box 132 for a specific chemical filter. The chemical contaminants include NOX, SO₂, VOC and ammonia. Exposure to each chemical contaminant over a period time is preferably calculated from the time spent in every geographic location and the chemical contaminants in the geographic location by a telematic software routine 134. When at least one of the chemical contaminants reaches the maximum threshold, the chemical filter 120 must be replaced.

However, saturation or insufficient trapping efficiency of the chemical filter 120 could be modelled according to a summation of instantaneous trapping efficiency and concentrations of chemical contaminants. The rate of contaminant accumulation on the filter can be adjusted to include an ascribed trapping efficiency. Since trapping efficiency decreases as a fill state of the chemical filter 120 increases, the accumulation rate can be based on the following equation:

$${\sum }_{t = 0}^{n} [ contaminant concentration ] @ {t}_{n} * [ trapping efficiency ] @ {t}_{n}$$

The above calculations would be implemented by the telematic software routine 134. If the vehicle operates in geographic area(s) where ambient concentrations of chemical contaminants are high, the chemical filter 120 must be replaced more frequently. If the vehicle operates in geographic area(s) where ambient concentrations of chemical contaminants are low, the chemical filter 120 is replaced less frequently. An accurate count of chemical contaminants in the chemical filter 120 will ensure that the fuel cell 100 is protected from damage, while minimizing down time and reducing cost of ownership of the vehicle.

The telematic software routine 134 will receive historical data 128 or live data 130 concerning the chemical contaminants in at least one geographic area in which the vehicle is driven. The telematic software routine 134 is preferably retained in an ECM/VCM (engine control module) (vehicle control module) 136 or any other suitable control module in the vehicle. The ECM directly controls all the parameters that are monitored through direct connections to vehicle sensors and actuators. The VCM acts as a central control and coordination hub for many subsystems' ECMs using high-level commands. When the chemical filter 120 is deemed to be saturated with at least one chemical contaminant by the telematic software routine 132, an alert is sent to an operator control screen 138 to change the chemical filter 120.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed:

1. A method of utilizing telematics to determine when a chemical contaminant saturation level of an air filter used in a fuel cell of a vehicle has been reached, comprising the steps of:
tracking at least one geographic location of a vehicle when the fuel cell is supplying electrical power;
recording the amount of time spent in the at least one geographic location when the fuel cell is supplying electrical power;
providing a concentration of at least one chemical contaminant in the at least one geographic location;
calculating the total ppm or concentration of each one of the at least one chemical contaminant encountered in the at least one geographic location; and
indicating that said air filter has reached a maximum saturation of at least one of the at least one chemical contaminant.

2. The method of utilizing telematics of claim 1 wherein:
said concentration of the at least one chemical contaminant is provided by a historical database.

3. The method of utilizing telematics of claim 1 wherein:
said concentration of the at least one chemical contaminant is provided by a live broadcast.

4. The method of utilizing telematics of claim 1 wherein:
the geographic location is determined with GPS.

5. The method of utilizing telematics of claim 1 wherein:
the at least one chemical contaminant includes at least one of NOX, SO₂, VOC and ammonia.

6. The method of utilizing telematics of claim 1, further comprising:
an operator display device for alerting a vehicle operator that said air filter has reached said maximum saturation of the at least one chemical contaminant.

7. A method of utilizing telematics to determine when a chemical contaminant saturation level of an air filter used in a fuel cell of a vehicle has been reached, comprising the steps of:
tracking a geographic location of a vehicle when the fuel cell is supplying electrical power;
recording the amount of time spent in the geographic location when the fuel cell is supplying electrical power;
providing a concentration of at least one chemical contaminant in the geographic location;
determining a maximum ppm or maximum concentration for each one of the at least one chemical contaminant which will be trapped in said air filter;
calculating the total ppm or concentration of each one of the at least one chemical contaminant encountered in the at least one geographic location; and
indicating that said air filter has reached a maximum saturation of at least one of the at least one chemical contaminant.

8. The method of utilizing telematics of claim 7 wherein:
said concentration of the at least one chemical contaminant is provided by a historical database.

9. The method of utilizing telematics of claim 7 wherein:
said concentration of the at least one chemical contaminant is provided by a live broadcast.

10. The method of utilizing telematics of claim 7 wherein:
the geographic location is determined with GPS.

11. The method of utilizing telematics of claim 7 wherein:
the at least one chemical contaminant includes at least one of NOX, SO₂, VOC and ammonia.

12. The method of utilizing telematics of claim 7, further comprising:
an operator display device for alerting a vehicle operator that said air filter has reached said maximum saturation of said at least one chemical contaminant.

13. A method of utilizing telematics to determine when insufficient trapping efficiency has been reached in an air filter from at least one chemical contaminant for a fuel cell of a vehicle, comprising the steps of:
tracking a geographic location of a vehicle when the fuel cell is supplying electrical power;
recording the amount of time spent in the geographic location when the fuel cell is supplying electrical power;
providing a concentration of at least one chemical contaminant in the geographic location;
providing a trapping efficiency of said air filter;
summing instantaneous trapping efficiency and concentration of at least one chemical contaminant, adjusting a rate of chemical contamination in said air filter to provide a remaining trapping efficiency in said air filter;
alerting a vehicle operator when said air filter has reached the insufficient trapping efficiency of the at least one chemical contaminant.

14. The method of utilizing telematics of claim 13 wherein:
said concentration of the at least one chemical contaminant is provided by a historical database.

15. The method of utilizing telematics of claim 13 wherein:
said concentration of the at least one chemical contaminant is provided by a live broadcast.

16. The method of utilizing telematics of claim 13 wherein:
the geographic location is determined with GPS.

17. The method of utilizing telematics of claim 13 wherein:
the at least one chemical contaminant includes at least one of NOX, SO₂, VOC and ammonia.

18. The method of utilizing telematics of claim 13, further comprising:
an operator display device for alerting the vehicle operator that said air filter has reached the insufficient trapping efficiency of the at least one chemical contaminant.

19. The method of utilizing telematics of claim 13, further comprising:
a telematic software routine for summing instantaneous trapping efficiency and concentration of at least one chemical contaminant.

20. The method of utilizing telematics of claim 19, further comprising:
said telematic software routine residing in a vehicle control module of an engine control module.
